(19) United States
(12) Patent Application Publication
(10) Pub. No.: US 2013/0243964 A1
(43) Pub. Date: Sep. 19, 2013

(54) METHOD FOR FOMING PHOSPHOR MATERIAL ON SURFACE OF TARGET

(71) Applicant: ACHROLUX INC., Sunnyvale, CA (US)

(72) Inventors: Peiching Ling, Sunnyvale, CA (US); Dezhong Liu, Sunnyvale, CA (US)

(73) Assignee: ACHROLUX INC., Sunnyvale, CA (US)

(21) Appl. No.: 13/799,283

(22) Filed: Mar. 13, 2013

Related U.S. Application Data
(60) Provisional application No. 61/610,935, filed on Mar. 14, 2012.

(51) Int. Cl. B05D 5/00; B05D 1/00

(52) U.S. Cl. CPC B05D 5/00; B05D 1/007
USPC 427/475; 118/621

(57) ABSTRACT

A method for forming a phosphor material on a surface of a target is provided. The method includes the steps of: providing a chamber for receiving the phosphor material, which is constituted by a plurality of particles; exposing the surface of the target to the phosphor material; and creating a charge on the plurality of particles and generating an electric field between the chamber and the surface of the target, so as to drive the plurality of particles toward the surface of the target and to be deposited on the surface of the target.

### 1. FIELD OF THE INVENTION

The present invention relates to methods for forming a phosphor material on a surface of a target, and more particularly, to a method and an apparatus for forming a uniform coating for converting an LED light-emitting wavelength.

### 2. BACKGROUND OF RELATED ART

The present invention generally relates to material manufacturing and an optical equipment technology. More specifically, the examples of the present invention provide a method for forming a uniform material layer and a system, which can be used in an optical system (such as a phosphorous layer in the lens of an LED). The term “phosphor” used herein refers to any luminescent materials, which absorb light of one wavelength and emit light of a different wavelength. As used herein, the terms “phosphor” and “wavelength-conversion material” can be used interchangeably.

Phosphors have been widely used in the productions of white-light LED packages or various blue pump LEDs (for example, yellow or red colors converted by phosphors) for producing light colors. The conventional methods for depositing phosphors on a blue LED die or a package include:

slurry method: phosphor particles are dispersed throughout a silicone resin, an epoxy resin or a solvent filler material, to form a mixture of phosphors, which is applied to an LED surface or the lens material of a package by various technologies such as spray-coating, dip-coating, dispensing, phosphors in a container, or molding on a support structure; and

electrophoretic deposition: phosphor particles are dispersed throughout an electrochemical solution, and then deposited on an LED wafer by a bias voltage bridging over an LED wafer and the electrochemical solution.

The above conventional methods have a difference in the uniformity of thickness across an LED surface or the interior of an LED package. The slurry method usually forms a particle layer with an uneven thickness, leading to inconsistent light spots of an LED and poor LED color uniformity as converted by phosphors. Moreover, it is difficult to use these conventional methods on a non-planar surface to form a uniform phosphorous layer, such that these conventional methods face big challenges in satisfying the requirements of lighting applications.

Accordingly, it is an important issue to form a uniform phosphorous material.

### SUMMARY OF THE INVENTION

The present invention provides a method for forming a phosphor material on a surface of a target, including the steps of: providing a chamber for receiving the phosphor material, the phosphor material being comprised of a plurality of particles; exposing the surface of the target to the phosphor material; and creating a charge on the plurality of particles, and generating an electric field between the chamber and the surface of the target, such that the plurality of particles are driven toward the surface of the target and deposited on the surface.

In one embodiment, the surface of the target is exposed over the phosphor material.

In one embodiment, the phosphor material received in the chamber constitutes a surface, on or below which a mesh or grid is disposed. The electric field is generated between the surface of the target and the mesh, or between the surface of the target and the grid. Moreover, the mesh or grid has electrical conductivity. Furthermore, the method further includes the step of driving the mesh or grid with a horizontal or vertical reciprocating motion on the surface constituted by the phosphor material received in the chamber.

The present invention further provides an apparatus for implementing the method of the present invention. The apparatus includes a holder for holding the target; a chamber for receiving the phosphor material, the chamber being disposed beneath the holder; a mesh disposed atop or beneath the surface constituted by the phosphor material received in the chamber; and a voltage power supply electrically connected to the mesh, so as to create a charge on the phosphor material, generate an electrical field between the chamber and the surface of the target, and deposit the phosphor material on the surface of the target.

In another embodiment, the mesh can be replaced with a grid.

In the present invention, the target can be a lens, a lens forming mold, an LED die, glass, a film, a metal, and the like.

Further, the plurality of particles are phosphor particles, binder particles, a mixture of the phosphor particles and binder particles, or in the form of phosphor particles covered with a binder material.

In the apparatus of the present invention, the voltage power supply includes a voltage supply element electrically connected to the mesh or grid; a conversion element electrically connected to the voltage supply element; and a controller for controlling the conversion element.

In one embodiment, the apparatus of the present invention further includes a conductive element disposed below the chamber, and electrically connected to the voltage power supply for potential oscillation.

In one embodiment, the apparatus of the present invention further includes a reciprocation driving mechanism for driving the mesh or grid with a reciprocating motion.

The method of the present invention drives the plurality of particles towards the surface of the target and to be deposited on the surface of the target, by creating a charge on the plurality of particles and generating an electrical field between the chamber and the surface of the target. Hence, the thicknesses of the particles are extremely thin and uniform after stacking.

### BRIEF DESCRIPTIONS OF THE DRAWINGS

FIGS. 1A and 1B are schematic diagrams showing the structures of LED lens;

FIG. 1C is a schematic diagram showing an array of LED assemblies;

FIG. 2A shows a homogenous LED phosphorous layer formed in a convex surface of a male lens forming mold in accordance with the method of the present invention;

FIG. 2B shows a homogenous LED phosphorous layer formed in a concave surface of a female lens forming mold in accordance with the method of the present invention;

FIGS. 2C and 2D show homogenous LED phosphorous layers formed in the flat surface or arculate surface of the female lens forming mold or the male lens forming mold according to the present invention;

FIGS. 3A and 3B show homogenous LED phosphorous layers formed on LED dice according to the present invention;

FIG. 4A shows an apparatus for forming a phosphor material of the present invention;

FIG. 4B shows an apparatus for forming a phosphor material of the present invention, wherein the apparatus includes a pan having a porous structure;

FIG. 5C is a schematic diagram showing a grid according to the present invention;

FIG. 5D is a schematic diagram showing that the grid is annular according to the present invention;

FIG. 5E is a schematic diagram showing that the mesh is rectangular;

FIGS. 6A and 6B show that the mesh is disposed on a surface constituted by the phosphor material or buried beneath the surface constituted by the phosphor material according to the present invention;

FIG. 7 illustrates a method for forming a phosphor material on a surface of a target of the present invention; and

FIG. 8 is a schematic diagram showing a direct voltage supply in the establishment of an electric field according to the present invention.

### DETAILED DESCRIPTION OF THE PREFERRED EMBODIMENTS

In the following, specific embodiments are provided to illustrate the detailed description of the present invention. Those skilled in the art can easily conceive the other advantages and effects of the present invention, based on the disclosure of the specification. The present invention can also be carried out or applied by other different embodiments. Each of the details in the specification of the present invention can also be modified or altered in view of different viewpoints and applications, without departing from the spirit of the creation of the present invention.

The structures, proportions, and sizes illustrated in the appended drawings of the specification of the present invention are merely for coping with the disclosure of the specification, in order to allow those skilled in the art to conceive and peruse it. The drawings are not for constraining the limitations of the present invention, such that they do not have any technical significance. Any structural modifications, alterations of proportions and adjustments of sizes, as long as not affecting the effect brought about by the present invention and the purpose achieved by the present invention, should fall within the range encompassed by the technical content disclosed in the present invention. At the same time, the language used in the specification of the present invention is merely for the clarity of expression, and not intended to limit the scope of the present invention. The alterations or adjustments of the relative relationships, while not substantially altering the technical content, can also be regarded as fallen within the scope of the present invention.

According to the method of the present invention, a homogenous coating can be formed on an LED unit or an array constituted by a plurality of LED units, for example, a phosphor material or a phosphorous layer formed on a surface of a target.

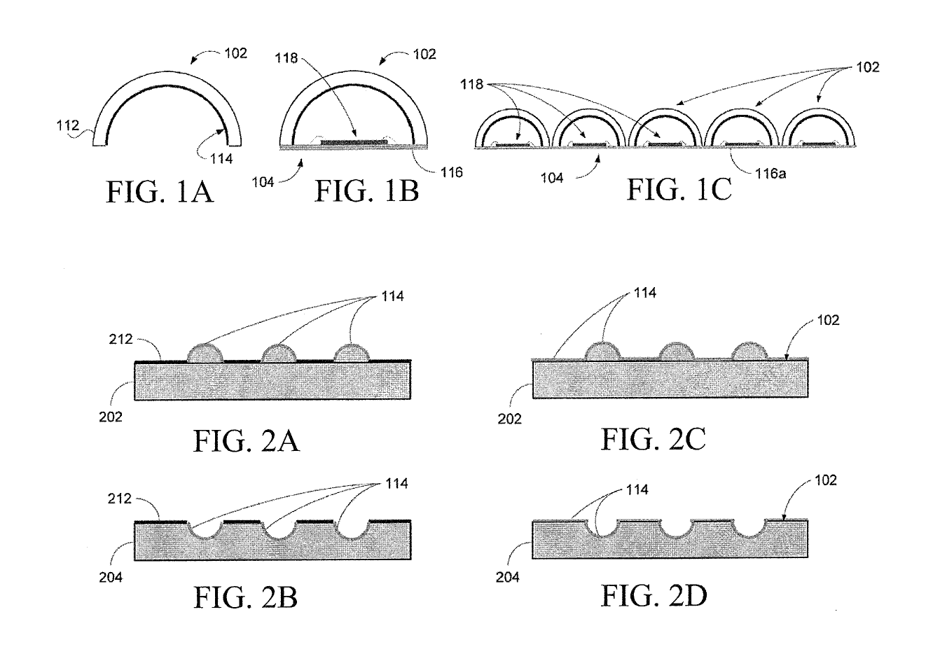

The homogenous coating can be formed on any suitable surface. For example, referring to FIGS. 1A and 1B, an LED lens structure 102 includes a lens element 112 and a homogenous LED phosphorous layer 114 formed on an inner surface of the lens element 112.

FIG. 1B shows that the LED lens structure 102 is mounted onto an LED assembly 104, which includes a board 116 and an LED die 118. FIG. 1C is a schematic diagram showing an array of LED unit 104.

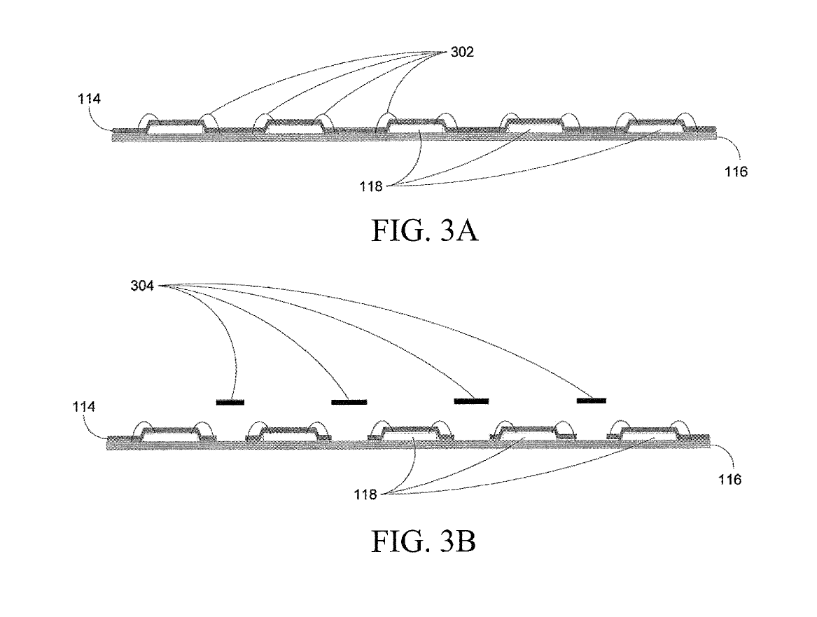

As shown in FIG. 2A, the homogenous LED phosphorous layer 114 is formed, in accordance with the present invention, on any convex surfaces of a male lens forming mold 202, wherein the homogeneous LED phosphorous layer 114 can only be formed on the convex surfaces of the male lens forming mold 202 by the use of a protection mask 212.

Similarly, as shown in FIG. 2B, the homogenous LED phosphorous layer 114 can be formed on the concave surfaces of a female lens forming mold 204.

FIGS. 2C and 2D show that the homogenous LED phosphorous layer 114 is formed on the flat surfaces and arculate surfaces of the male lens forming mold 202 and female lens forming mold 204, respectively.

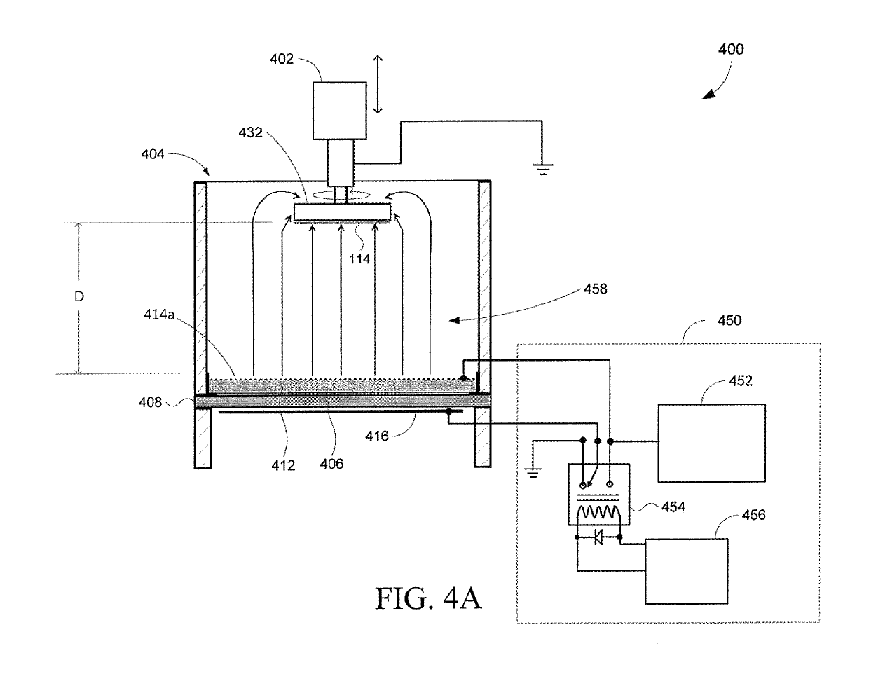

FIGS. 3A and 3B show that the homogenous LED phosphorous layer 114 is formed on the LED die 118, and the plurality of LED units 104 having the LED dice 118 are in an array configuration, wherein bonding wires 302 are electrically connected to the board 116. Moreover, as shown in FIG. 3B, a mask 304 can be used to prevent the formation of the homogenous LED phosphorous layer 114 on certain areas.

As shown in FIGS. 1 to 3, the target described in the present invention may be, but not limited to, a lens, a lens forming mold, an LED die, etc.

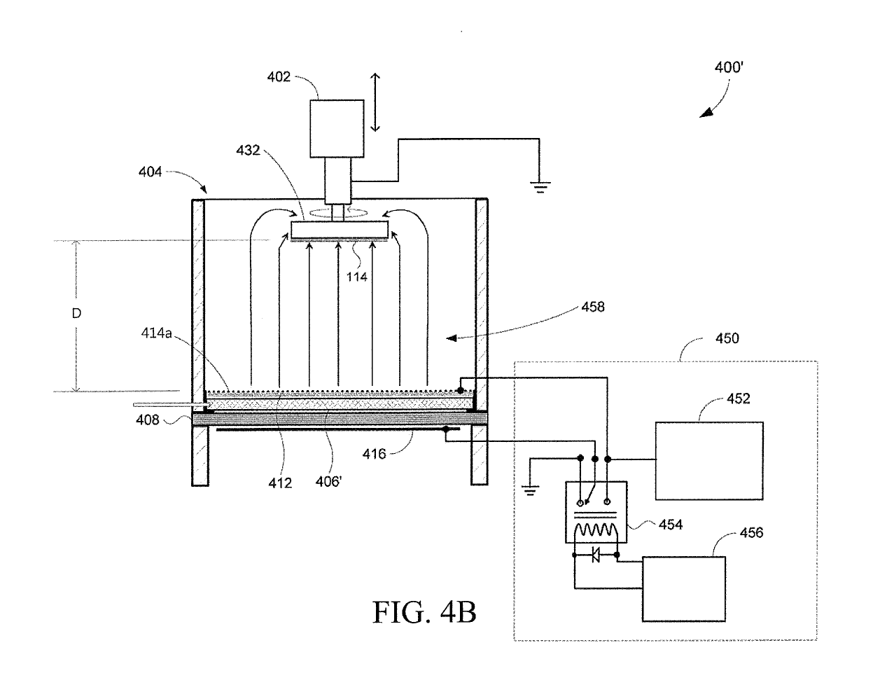

Referring to FIG. 4, an apparatus 400 for forming a phosphor material of the present invention is illustrated. The apparatus 400 includes a holder 402, a chamber 404, a mesh 414a and a voltage power supply 450.

The holder 402 is used for holding a target 432. For example, the carrier 402 has clamps or a suction element for holding the target 432. On the other hand, the holder 402 can be equipped with a driving unit, such as a motor, to revolve the target 432 or to drive the target 432 towards the interior of the chamber 404, so as to expose the surface of the target 432 to the phosphor material. For example, the target 432 can revolve at one and half to several revolutions per minute.

Moreover, the target 432 can be grounded by, for example, allowing the holder 402 to be grounded in the method of the present invention.

The chamber 404 can be made of non-conductive materials, such as plastic materials, for example, nylon, Plexiglas®, etc.

The chamber 404 can have a pan 406 for receiving or loading a phosphor material 412. Moreover, the phosphor material is constituted by a plurality of particles, which are phosphor particles, binder particles, a mixture of the phosphor particles and the binder particles, or phosphor particles covered with a binder material. That is, the phosphor material is powder. Further, in addition to being phosphor powder, the phosphor material can be quantum dot powders, such as red or green quantum dot powders.

In the method of the present invention, the surface of the target 432 is exposed over the phosphor material 412. In one example, the target 432 is spaced apart from the pan 406 or the phosphor material 412 by a separation distance D, which is, for example, from 100 mm to 250 mm.

As shown in FIG. 4A, the mesh 414a is disposed on the surface constituted by the phosphor material 412 or buried beneath the surface constituted by the phosphor material 412.

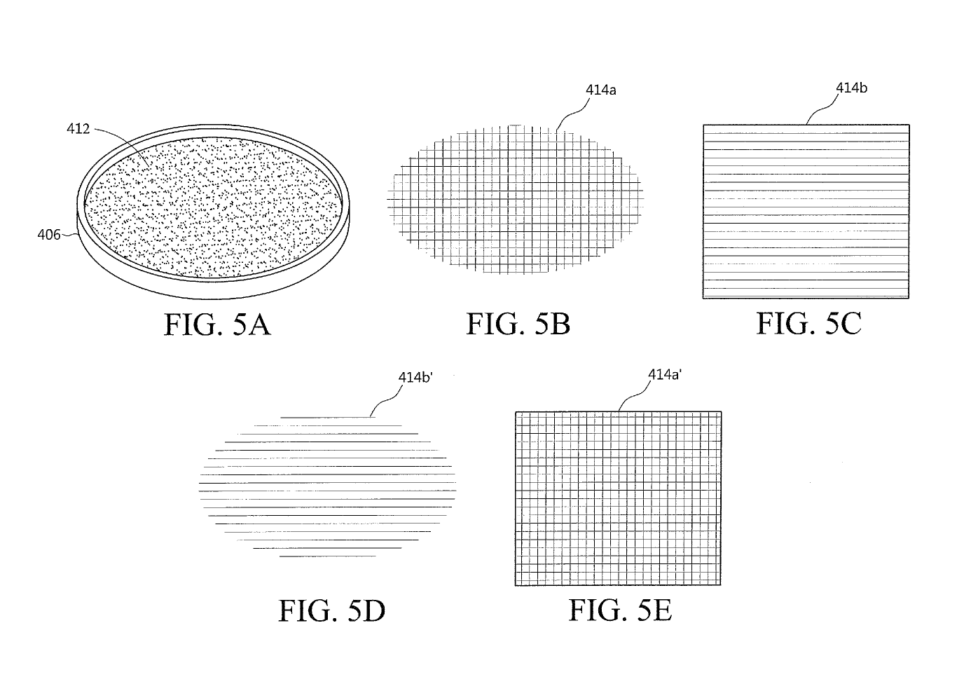

As shown in FIG. 5B, the mesh 414a is constituted by a plurality of interlaced conductive traces. The conductive traces have separation distances, and separation distance is in, but not limited to, a range from 5 mm to 10 mm. The mesh 414a can be disposed on the pan 406, as shown in FIG. 5A.

Moreover, the mesh can be replaced with a grid. As shown in FIG. 5C, the grid 414b is constituted by a plurality of parallel fine lines, and is rectangular. As shown in FIG. 5D, the grid 414b′ can be annular. As shown in FIG. 5E, the mesh 414a′ can be rectangular.

Further, the grid is electrically conductive, and includes fine metal lines or fine lines covered with metals. Moreover, the appearance of the grid is not particularly limited. However, the grid is preferably rectangular, which facilitates the consistency in the oscillation frequency of each of the fine lines.

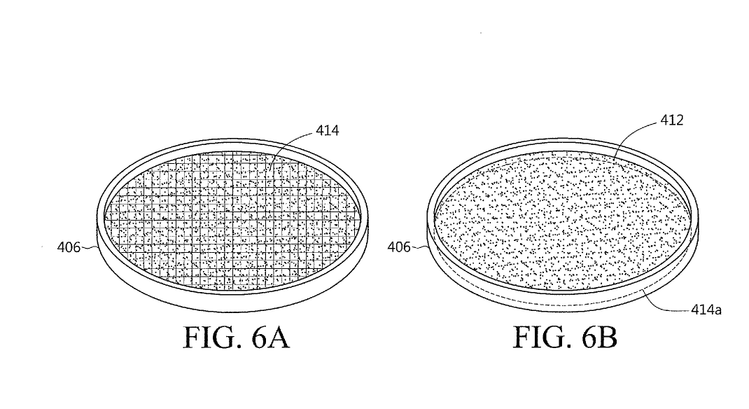

As shown in FIGS. 6A and 6B, the mesh 414a is disposed above the surface constituted by the phosphor material 412 or buried beneath the surface constituted by the phosphor material 412.

Referring again to FIG. 4A, the apparatus for forming a phosphor material further includes a conductive element 416 disposed beneath the chamber 404. The conductive element 416 is electrically connected to the voltage power supply 450 to perform potential oscillation. In one embodiment, the conductive element 416 can be an oscillation plate. Moreover, the mesh 414a and the conductive element 416 are electrically insulated or isolated. For example, an insulator 408 of the chamber 404 can be used to insulate the conductive element 416 from the pan 406, so as to achieve electrical insulation or electrical isolation between the mesh 414a and the conductive element 416. The insulator 408 can be nylon, Teflon® or other insulating materials.

The power voltage supply 450 is electrically connected to the mesh 414a, so as to create a charge on the phosphor material 412, and generate an electric field 458 between the chamber 404 and the surface of the target 432 to facilitate the deposition of a phosphor material on the surface of the target 432. The voltage power supply 450 includes a voltage supply element 452 electrically connected to the mesh 414a; a conversion element 454 electrically connected to the voltage supply element 452; and a controller 456 for controlling the conversion element 454 to change the voltage potential outputted by the voltage supply element 452.

Furthermore, the conductive element 416 is also electrically connected to the voltage supply element 450. In an example, the conductive element 416 is also electrically connected to the conversion element 454.

The voltage supply element 452 provides adjustable voltages, such as direct voltages from 10 kV to 80 kV.

In addition to being electrically connected to the voltage supply element 452, the conversion element 454 can also be grounded. That is, the conversion element 454 can be switched between being grounded and the power supply element 452.

The controller 456 switches at a frequency of 50 to 90 cycles per minute with a 50% duty cycle, but other operations frequencies may also be used.

In operation, the target 432, being electrically connected to a ground potential, serves as an anode. The mesh 414a serves as a cathode. The conductive element 416 switches between the ground voltage and the voltage supplied by the voltage supply element 452. When the potential of the conductive element 416 changes between the ground potential and the voltage supplied by the voltage supply element 452, an electric field 458 is generated between the anode and the cathode. Further, the voltage applied on the mesh 414a creates a charge on the phosphor material 412. In other words, a charge is created on the plurality of particles, so as to drive the plurality of particles toward the surface of the target 432 and cover the surface of the target 432, thereby forming the homogenous phosphorous layer 114.

Referring to FIG. 4B, in order to uniformly distribute the phosphor material 412 in the pan 406′, thereby facilitating the plurality of particles to move consistently with electric field lines, the pan 406′ of the apparatus 400′ can have a porous structure, into which a small amount of air is permitted to pass, and then escapes through the upper surface of the pan 406. Thus, the plurality of particles would be loosed without becoming airborne. In one embodiment, the pan 406′ can be a porous bed.

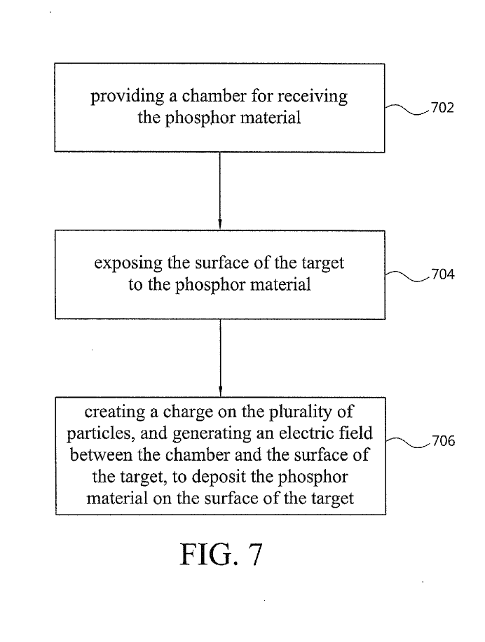

Referring again to FIG. 7, the method for forming a phosphor material on a surface of a target of the present invention includes: in step 702, providing a chamber for receiving the phosphor material, wherein the phosphor material is constituted by a plurality of particles; in step 704, the surface of the target is exposed to the phosphor material; and in step 706, creating a charge on the plurality of particles, and generating an electric field between the chamber and the surface of the target, to deposit the phosphor material on the surface of the target.

It should be appreciated that the method illustrated in FIG. 7 can be repeated, in order to obtain a multi-layered structure, for example, a formed phosphor material layer with various colors of light, or a layer constituted by binder particles.

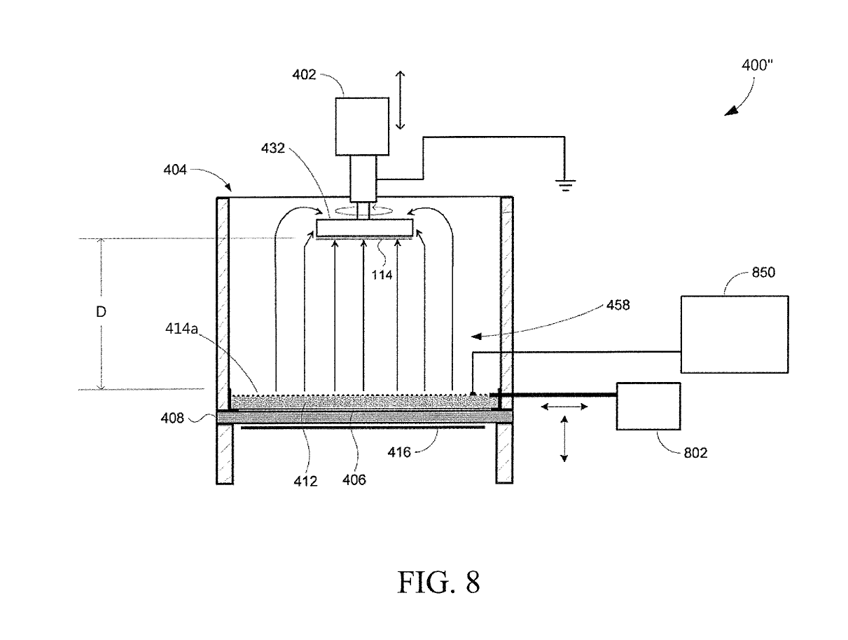

The voltage power supply 450 shown in FIG. 4 can be a direct power source. As shown in FIG. 8, the direct voltage supply 850 can be used to establish an electric field. Moreover, the apparatus 400″ for forming a phosphor material can further include a reciprocation driving mechanism 802 for driving the mesh 414a with a reciprocating motion. The reciprocating motion may be a horizontal or vertical movement as shown in FIG. 8. At the same time, an electric field is also generated between the mesh 414a and the target 432, so as to create a charge on the plurality of particles, and thus to drive the plurality of particles toward the surface of the target and to be deposited on the surface of the target.

In one embodiment, the frequency of the reciprocating motion is from 30 to 90 cycles per minute, but other frequencies can also be used.

According to the method of the present invention, the phosphor material in the chamber moves to the surface of the target due to the generation of an electric field, instead of using a flow of air to carry the phosphor material. Thus, the phosphor material is not influenced by the turbulence of the airflow.

The above examples are only used to illustrate the principle of the present invention and the effect thereof, and should not be construed as to limit the present invention. The above examples can all be modified and altered by those skilled in the art, without departing from the spirit and scope of the present invention as defined in the following appended claims.

1. A method for forming a phosphor material on a surface of a target, comprising the steps of:
providing a chamber for receiving the phosphor material, the phosphor material being constituted by a plurality of particles;
exposing the surface of the target to the phosphor material; and
creating a charge on the plurality of particles, and generating an electric field between the chamber and the surface of the target, so as to drive the plurality of particles toward the surface of the target and to be deposited on the surface of the target.

2. The method of claim 1, wherein the surface of the target is exposed over the phosphor material.

3. The method of claim 1, wherein the phosphor material received in the chamber constitutes a surface, on or beneath which one of a mesh and a grid is disposed, and the electric field is generated between the surface of the target and the mesh or between the surface of the target and the grid.

4. The method of claim 3, wherein the one of the mesh and the grid has electrical conductivity.

5. The method of claim 3, further comprising a step of driving the one of the mesh and grid with a horizontal or vertical reciprocating motion on the surface constituted by the phosphor material received in the chamber.

6. The method of claim 1, wherein the target is selected from the group consisting of a lens, a lens forming mold, an LED die, glass, a film, and a metal.

7. The method of claim 1, wherein the plurality of particles are selected from the group consisting of phosphor particles, binder particles, a mixture of the phosphor particles and the binder particles, and phosphor particles covered with a binder material.

8. A apparatus for forming a phosphor material on a surface of a target, comprising:
a holder for holding the target;
a chamber for receiving the phosphor material, the chamber being disposed beneath the holder;
a mesh disposed on or beneath a surface constituted by the phosphor material received in the chamber; and
a voltage power supply electrically connected to the mesh for creating a charge on the phosphor material and generating an electric field between the chamber and the surface of the target, so as to deposit the phosphor material on the surface of the target.

9. The apparatus of claim 8, wherein the voltage power supply comprises:
a voltage power supply element electrically connected the mesh;
a conversion element electrically connected to the voltage supply element; and
a controller for controlling the conversion element.

10. The apparatus of claim 8, further comprising a conductive element disposed beneath the chamber, and electrically connected to the voltage power supply to perform potential oscillation.

11. The apparatus of claim 8, further comprising a reciprocation driving mechanism for driving the mesh with a reciprocating motion.

12. A apparatus for forming a phosphor material on a surface of a target, comprising:
a holder for holding the target;
a chamber for receiving the phosphor material, and the chamber being disposed beneath the holder;
a grid disposed on or beneath a surface constituted by the phosphor material received in the chamber; and
a voltage power supply electrically connected to the grid for creating a change on the phosphor material and generating an electric filed between the chamber and the surface of the target, so as to deposit the phosphor material on the surface of the target.

13. The apparatus of claim 12, wherein the voltage power supply comprises:
a voltage power supply element electrically connected to the grid;
a conversion element electrically connected to the voltage supply element; and
a controller for controlling the conversion element.

14. The apparatus of claim 12, further comprising a conductive element disposed beneath the chamber, and electrically connected to the voltage power supply to perform potential oscillation.

15. The apparatus of claim 12, further comprising a reciprocation driving mechanism for driving grid with a reciprocating motion.
